(19) United States
(12) Patent Application Publication
(10) Pub. No.: US 2025/0053785 A1
(43) Pub. Date: Feb. 13, 2025

(54) SYSTEMS AND METHODS FOR PREDICTING PRESENCE OF OBJECTS USING DECENTRALIZED DATA COLLECTION AND MAP DATA-BASED INFORMATION COMPRESSION

(71) Applicant: Toyota Motor Engineering & Manufacturing North America, Inc., Plano, TX (US)

(72) Inventors: Chianing Wang, Mountain View, CA (US); Haoxiang Yu, Austin, TX (US)

(73) Assignees: Toyota Motor Engineering & Manufacturing North America, Inc., Plano, TX (US); Toyota Jidosha Kabushiki Kaisha, Toyota-shi, Aichi-ken (JP)

(21) Appl. No.: 18/232,964

(22) Filed: Aug. 11, 2023

(51) Int. Cl. G06N 3/0455; G06N 3/0442; G06N 3/08

(52) U.S. Cl. CPC G06N 3/0455; G06N 3/0442; G06N 3/08

(57) ABSTRACT

A method for predicting presence of objects in an area is provided. The method includes obtaining a 2-dimensional matrix representing presence of objects in an area, each of values of the 2-dimensional matrix representing presence of objects in corresponding sub-region of the area, filtering the 2-dimensional matrix based on map information, converting the filtered 2-dimensional matrix to 1-dimensional data, inputting a series of the 1-dimensional data to a trained prediction machine learning model to obtain 1-dimensional data for future presence of objects, and converting the 1-dimensional data for future presence of objects to a 2-dimensional matrix representing the future presence of objects.

### TECHNICAL FIELD

The present disclosure relates to systems and methods for determining long-term situational awareness for objects such as vehicles, more specifically, to systems and methods for predicting presence of objects using decentralized data collection and city map data-based information compression.

### BACKGROUND

Traditional machine learning is centralized and needs lots of infrastructure resource to support training. Distributed learning methods include decentralized learning and federated learning. The federated learning is a method where clients, e.g., vehicles train a model locally and upload the model to a central server, and the central sever aggregates the trained models from edge devices and sends the aggregated model back to the clients. On the other hand, decentralized learning involves distributing the training process across multiple clients such as vehicles or edge devices such as road-side devices that are connected in a peer-to-peer network. Each client processes a portion of the data and communicates with other clients to share information.

Federated learning requires lots of communication among vehicles, edge servers, and a central server for updating a machine learning model. Whereas decentralized learning does not rely on a central server. Decentralized learning requires that each vehicle identify the locations of other vehicles, edge servers, and other components. However, conventional decentralized learning only considers short-term situational awareness that allows vehicles to perceive their immediate surroundings.

Accordingly, a need exists for systems and methods for long-term situational awareness for vehicles which utilizes information exchanged among vehicles to detect and understand the environment beyond the range of their own sensors

### SUMMARY

The present disclosure provides systems and methods for predicting presence of objects using decentralized data collection and city map data-based information compression.

In one embodiment, a method for predicting presence of objects in an area is provided. The method includes obtaining a 2-dimensional matrix representing presence of objects in an area, each of values of the 2-dimensional matrix representing presence of objects in corresponding sub-region of the area, filtering the 2-dimensional matrix based on map information, converting the filtered 2-dimensional matrix to 1-dimensional data, inputting a series of the 1-dimensional data to a trained prediction machine learning model to obtain 1-dimensional data for future presence of objects, and converting the 1-dimensional data for future presence of objects to a 2-dimensional matrix representing the future presence of objects.

In another embodiment, a system for predicting presence of objects in an area is provided. The system includes a controller programmed to: obtain a 2-dimensional matrix representing presence of objects in an area, each of values of the 2-dimensional matrix representing presence of objects in corresponding sub-region of the area, filter the 2-dimensional matrix based on map information, convert the filtered 2-dimensional matrix to 1-dimensional data, input a series of the 1-dimensional data to a trained prediction machine learning model to obtain 1-dimensional data for future presence of objects, and convert the 1-dimensional data for future presence of objects to a 2-dimensional matrix representing the future presence of objects.

In another embodiment, a non-transitory computer readable medium storing instructions predicting presence of objects in an area is provided. The instructions, when executed by a processor, cause the processor to: obtain a 2-dimensional matrix representing presence of objects in an area, each of values of the 2-dimensional matrix representing presence of objects in corresponding sub-region of the area, filter the 2-dimensional matrix based on map information, convert the filtered 2-dimensional matrix to 1-dimensional data, input a series of the 1-dimensional data to a trained prediction machine learning model to obtain 1-dimensional data for future presence of objects, and convert the 1-dimensional data for future presence of objects to a 2-dimensional matrix representing the future presence of objects.

These and additional features provided by the embodiments of the present disclosure will be more fully understood in view of the following detailed description, in conjunction with the drawings.

### BRIEF DESCRIPTION OF THE DRAWINGS

The embodiments set forth in the drawings are illustrative and exemplary in nature and not intended to limit the disclosure. The following detailed description of the illustrative embodiments can be understood when read in conjunction with the following drawings, where like structure is indicated with like reference numerals and in which:

FIG. 1A schematically depicts presence of vehicles in an area at time t1, in accordance with one or more embodiments shown and described herewith;

FIG. 1B schematically depicts presence of vehicles in an area at time t2, in accordance with one or more embodiments shown and described herewith;

FIG. 1C schematically depicts presence of vehicles in an area at time t3, in accordance with one or more embodiments shown and described herewith;

FIG. 2 depicts a schematic diagram of a system for long-term situational awareness for vehicles using decentralized data collocation and map data-based information compression, according to one or more embodiments shown and described herein;

FIG. 3 depicts a flowchart for predicting presence of objects using decentralized data collection and city map data-based information compression, according to one or more embodiments shown and described herein;

FIG. 4 depicts compressing data representing presence of vehicles in an area into 1-dimensional data, according to one or more embodiments shown and described herein;

FIG. 5 depicts processing of 1-dimensional data by an autoencoder, according to one or more embodiments shown and described herein;

FIG. 6 depicts schematic diagram of an autoencoder, according to one or more embodiments shown and described herein;

FIG. 7 depicts details of an LSTM prediction model, according to one or more embodiments shown and described herein;

FIG. 8 depicts an autoencoder that compresses and decompresses data using an encoder and a decoder, according to one or more embodiments shown and described herein;

FIG. 9 depicts a graph that depicts a mean square error (MSE) loss for different number of vectors that are used by the encoder and the decoder in a simulated city traffic area, according to one or more embodiments shown and described herein;

FIG. 10A depicts presence of vehicles in an area, according to one or more embodiments shown and described herein; and

FIG. 10B depicts prediction of presence of vehicles in an area, according to one or more embodiments shown and described herein.

### DETAILED DESCRIPTION

The embodiments disclosed herein include systems and methods for long-term situational awareness for vehicles using decentralized data collocation and map data-based information compression. According to the embodiments, a method for long-term situational awareness for vehicles is provided. The long-term situational awareness differs from the short-term situational awareness commonly used in the automotive industry. Unlike short-term situational awareness, which allows vehicles to perceive their immediate surroundings, the present disclosure focuses on long-distance situational awareness, which requires information exchange between vehicles to detect and understand the environment beyond the range of their own sensors. In particular, the present disclosure focuses on the information that can enhance model training and resource utilization, such as the location of other vehicles and road-side units (RSUs).

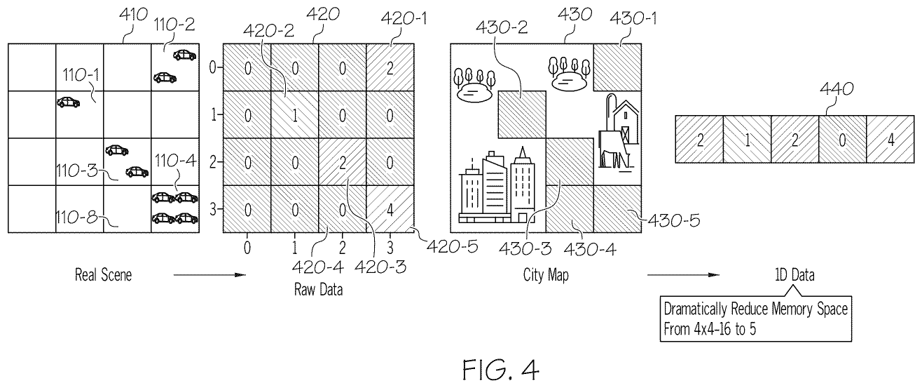

The present system consists of two major components. The first one is to compress highly sparse data into a low-dimensional representation that can be stored and shared using minimal resources. By referring to FIG. 4, the present system generates a 2-dimensional matrix 420 representing the presence of vehicles in the area 410. Then, the present system filters the 2-dimensional matrix based on map information 430. The map information may include information about drivable sub-regions and information about non-drivable sub-regions in the area. For example, by referring to FIG. 4, the sub-regions 430-1 through 430-5 are drivable sub-regions and the rest of the sub-regions are non-drivable. The present filters the 2-dimensional matrix based on map information by selecting values in the 2-dimensional matrix corresponding to the drivable sub-regions and removing values in the 2-dimensional matrix corresponding to the non-drivable sub-regions. For example, by referring to FIG. 4, only the sub-regions 430-1 through 430-5 remain and the rest of the sub-regions are removed. Then, the present system converts the filtered 2-dimensional matrix to 1-dimensional data. For example, by referring to FIG. 4, the remaining values for the sub-regions 420-1 through 420-5 in the filtered 2-dimensional matrix are converted to 1-dimensional data 440.

Because the first component compresses environmental information to 1-dimensional data, the present system reduces communication and storage resource usage, decreases feature dimensionality, reduces computational requirements, and improves the prediction model's performance.

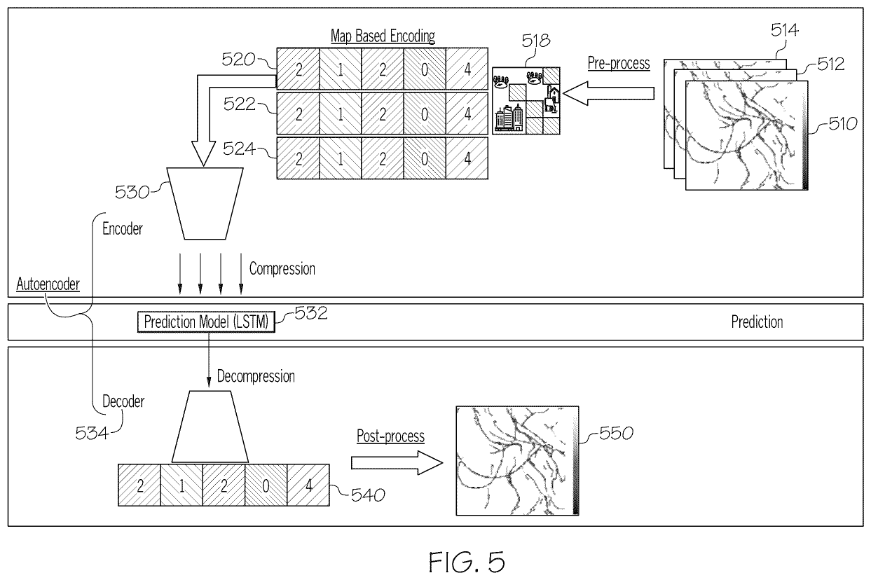

The second component involves using a time-series model to predict future scenarios. By referring to FIG. 5, the second component corresponds to the LSTM prediction model 532. A LSTM network is a type of recurrent neural network that is good at analyzing patterns over time and remembering information for a long time. The LSTM network works by using a special type of cell that can remember information and selectively forget or remember certain pieces of information.

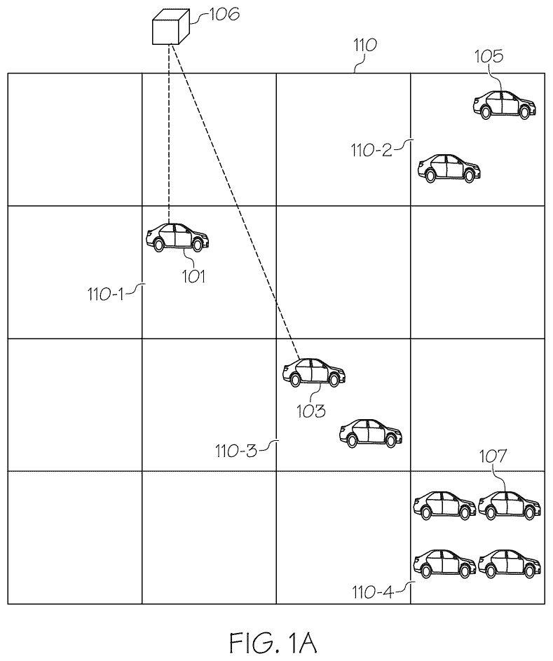

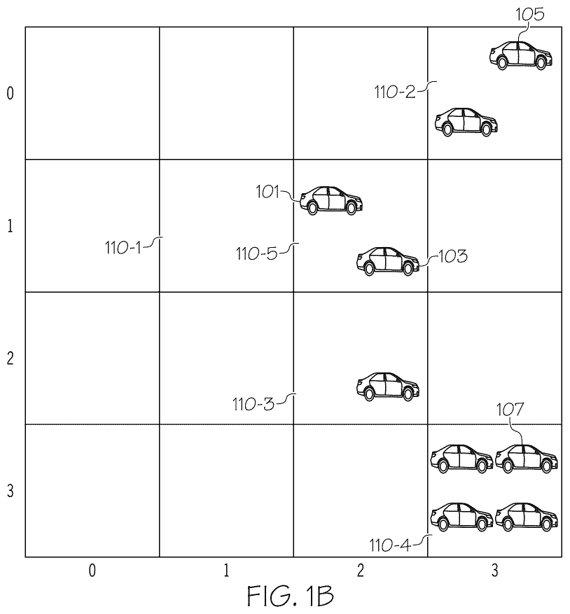

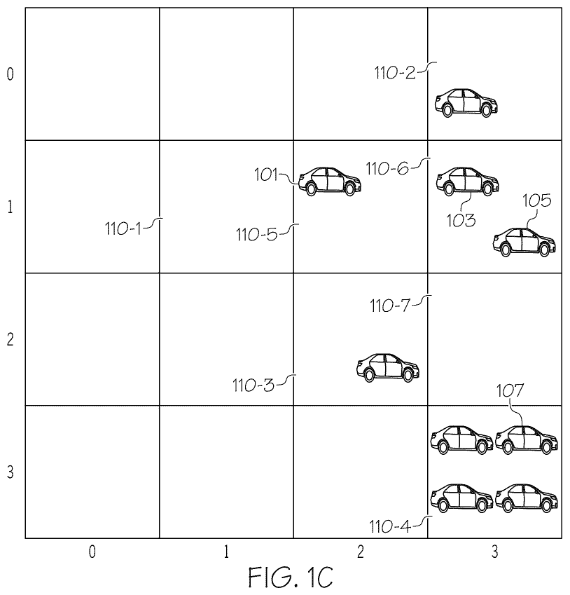

FIGS. 1A, 1, 1C schematically depict a plurality of vehicles present in an area at different times, in accordance with one or more embodiments shown and described herewith.

FIG. 1A depicts presence of vehicles in an area 110 at time t1. The area 110 includes a plurality of sub-regions including sub-regions 110-1, 110-2, 110-3, 110-4. For example, the area 110 includes 4 by 4 sub-regions, i.e., 16 sub-regions. While FIG. 1 depicts 16 sub-regions, more than or less than 16 sub-rejections may be included in the area 110. At time t1, a vehicle 101 is present at the sub-region 110-1. At time t1, the sub-region 110-2 includes two vehicles including a vehicle 105, the sub-region 110-3 includes two vehicles including a vehicle 103, and the sub-region 110-4 includes four vehicles including a vehicle 107. Each of the vehicles exchanges decentralized messages with vehicles that are within the sub-region. That is, vehicles within the same sub-region may directly communicate with each other without edge devices or a central server involved.

In embodiments, each of the vehicles detects other vehicles in the same sub-region by communicating decentralized messages. For example, the vehicle 101 does not identify other vehicles in the sub-region 110-1 at time t1, and stores information that there is one vehicle in the sub-region 110-1 at time t1. The vehicle 103 exchanges decentralized messages with another vehicle in the sub-region 110-3 at time t1, and stores information that there are two vehicles in the sub-region 110-3 at time t1. The vehicle 105 exchanges decentralized messages with another vehicle in the sub-region 110-2 at time t1, and stores information that there are two vehicles in the sub-region 110-2. The vehicle 107 exchanges decentralized messages with other vehicles in the sub-region 110-4 at time t1, and stores information that there are four vehicles in the sub-region 110-4 at time t1.

FIG. 1B depicts presence of vehicles in the area 110 at time t2. At time t2, the vehicle 101, which was previously in the sub-region 110-1, is now in the sub-region 110-5. The vehicle 101 exchanges decentralized messages with the vehicle 103 in the sub-region 110-5. For example, the vehicle 101 receives a message from the vehicle 103 that there were two vehicles in the sub-region 110-3 at time t1. Similarly, the vehicle 103 receives a message from the vehicle 101 that there was one vehicle in the sub-region 110-1 at time t1. The vehicle 105 exchanges decentralized messages with another vehicle in the sub-region 110-2 and stores information that there are two vehicles in the sub-region 110-2 at time t2. The vehicle 107 exchanges decentralized messages with other vehicles in the sub-region 110-4 at time t2, and stores information that there are four vehicles in the sub-region 110-4 at time t2.

FIG. 1C depicts presence of vehicles in the area 110 at time t3. At time t3, the vehicle 103, which was previously in the sub-region 110-5, is now in the sub-region 110-6. Similarly, at time t3, the vehicle 105, which was previously in the sub-region 110-2, is now in the sub-region 110-6. The vehicle 101 is still in the sub-region 110-5. The vehicle 103 exchanges decentralized messages with the vehicle 105 in the sub-region 110-6. For example, the vehicle 103 receives messages from the vehicle 105 that there were two vehicles in the sub-region 110-2 at time t1 and there were two vehicles in the sub-region 110-2 at time t2. Similarly, the vehicle 105 receives messages from the vehicle 103 that there was one vehicle in the sub-region 110-1 at time t1, there were two vehicles in the sub-region 110-3 at time t1, and there were two vehicles in the sub-region 110-5 at time t2. In this regard, the vehicle 105 learns that there was one vehicle in the sub-region 110-1 at time t1, there were two vehicles in the sub-region 110-3 at time t1, and there were two vehicles in the sub-region 110-2 at time t1.

The vehicle 105 may be in the same sub-region (e.g., the sub-region 110-7 or in the sub-region 110-4) with the vehicle 107 in the sub-region 110-4 in the future, for example, at time t4, and learned from the vehicle 107 that there were four vehicles in the sub-region 110-4 at time t1. Thus, the vehicle 105 may know the presence of all vehicles in the area 110 at time t1, i.e., one vehicle in the sub-region 110-1, two vehicles in the sub-region 110-2, two vehicles in the sub-region 110-3, and four vehicles in the sub-region 110-4. The information about the presence of all vehicles in the area 110 may be converted to 1-dimensional data, which will be described in detail with reference to FIG. 4 below.

In some embodiments, an edge device 106 may communicate with connected vehicles including one or more of the vehicles 101, 103, 105, 107 and store information about the presence of the vehicles at a certain time. For example, the edge device 106 may communicate with the vehicle 105 at time t2 and receive information that there was one vehicle in the sub-region 110-1 at time t1, there were two vehicles in the sub-region 110-3 at time t1, there were two vehicles in the sub-region 110-2 at time t1, and there were four vehicles in the sub-region 110-4 at time t1. In some embodiments, an edge device 106 is not included, and only vehicles exchange decentralized messages.

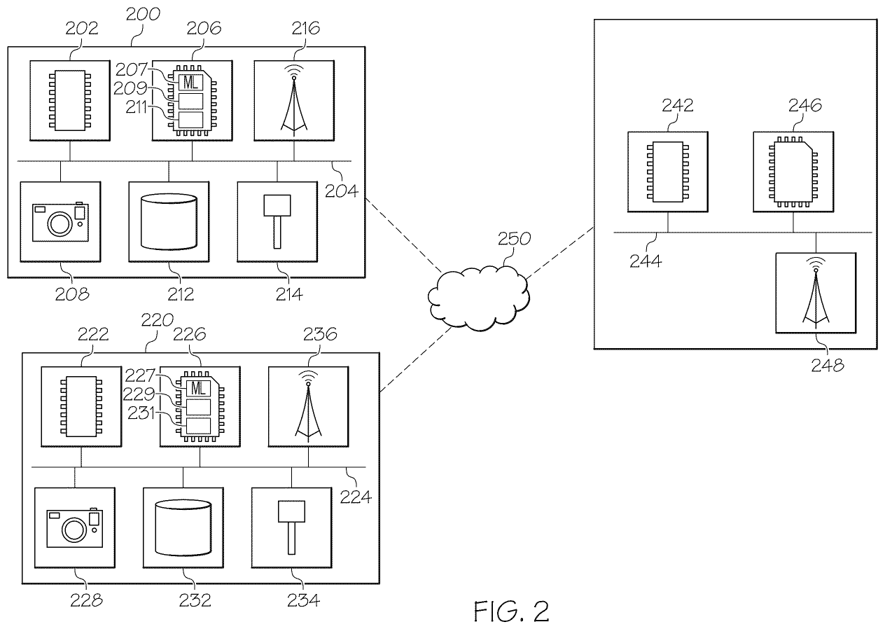

FIG. 2 depicts a schematic diagram of a system for long-term situational awareness for vehicles using decentralized data collocation and map data-based information compression, according to one or more embodiments shown and described herein. The system includes a first vehicle system 200 and a second vehicle system 220. In some embodiments, the system may also include an edge device 106. While FIG. 2 depicts two vehicle systems, more than two vehicle systems may communicate with the edge device 106.

It is noted that, while the first vehicle system 200 and the second vehicle system 220 are depicted in isolation, each of the first vehicle system 200 and the second vehicle system 220 may be included within a vehicle in some embodiments, for example, respectively within any two of the vehicles 101, 103, 105, 107 of FIG. 1. In embodiments in which each of the first vehicle system 200 and the second vehicle system 220 is included within an edge node, the edge node may be an automobile or any other passenger or non-passenger vehicle such as, for example, a terrestrial, aquatic, and/or airborne vehicle. In some embodiments, the vehicle is an autonomous vehicle that navigates its environment with limited human input or without human input. Each of the vehicles 101, 103, 105, 107 may include actuators for driving the vehicle, such as a motor, an engine, or any other powertrain.

The first vehicle system 200 includes one or more processors 202. Each of the one or more processors 202 may be any device capable of executing machine readable and executable instructions. Accordingly, each of the one or more processors 202 may be a controller, an integrated circuit, a microchip, a computer, or any other computing device. The one or more processors 202 are coupled to a communication path 204 that provides signal interconnectivity between various modules of the system. Accordingly, the communication path 204 may communicatively couple any number of processors 202 with one another, and allow the modules coupled to the communication path 204 to operate in a distributed computing environment. Specifically, each of the modules may operate as a node that may send and/or receive data. As used herein, the term “communicatively coupled” means that coupled components are capable of exchanging data signals with one another such as, for example, electrical signals via conductive medium, electromagnetic signals via air, optical signals via optical waveguides, and the like.

Accordingly, the communication path 204 may be formed from any medium that is capable of transmitting a signal such as, for example, conductive wires, conductive traces, optical waveguides, or the like. In some embodiments, the communication path 204 may facilitate the transmission of wireless signals, such as WiFi, Bluetooth®, Near Field Communication (NFC), and the like. Moreover, the communication path 204 may be formed from a combination of mediums capable of transmitting signals. In one embodiment, the communication path 204 comprises a combination of conductive traces, conductive wires, connectors, and buses that cooperate to permit the transmission of electrical data signals to components such as processors, memories, sensors, input devices, output devices, and communication devices. Accordingly, the communication path 204 may comprise a vehicle bus, such as for example a LIN bus, a CAN bus, a VAN bus, and the like. Additionally, it is noted that the term “signal” means a waveform (e.g., electrical, optical, magnetic, mechanical or electromagnetic), such as DC, AC, sinusoidal-wave, triangular-wave, square-wave, vibration, and the like, capable of traveling through a medium.

The first vehicle system 200 includes one or more memory modules 206 coupled to the communication path 204. The one or more memory modules 206 may comprise RAM, ROM, flash memories, hard drives, or any device capable of storing machine readable and executable instructions such that the machine readable and executable instructions can be accessed by the one or more processors 202. The machine readable and executable instructions may comprise logic or algorithm(s) written in any programming language of any generation (e.g., 1GL, 2GL, 3GL, 4GL, or 5GL) such as, for example, machine language that may be directly executed by the processor, or assembly language, object-oriented programming (OOP), scripting languages, microcode, etc., that may be compiled or assembled into machine readable and executable instructions and stored on the one or more memory modules 206. Alternatively, the machine readable and executable instructions may be written in a hardware description language (HDL), such as logic implemented via either a field-programmable gate array (FPGA) configuration or an application-specific integrated circuit (ASIC), or their equivalents. Accordingly, the methods described herein may be implemented in any conventional computer programming language, as pre-programmed hardware elements, or as a combination of hardware and software components. The one or more processor 202 along with the one or more memory modules 206 may operate as a controller for the first vehicle system 200.

The one or more memory modules 206 includes a machine learning (ML) model 207, a data conversion module 209, and an ML training module 211. Each of the ML model 207, the data conversion module 209, and the ML training module 211 may include, but not limited to, routines, subroutines, programs, objects, components, data structures, and the like for performing specific tasks or executing specific data types as will be described below.

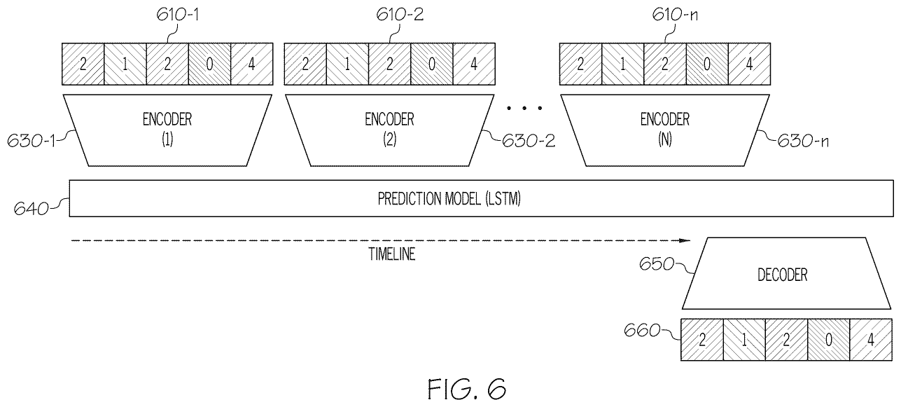

The ML model 207 may by a machine learning model including, but not limited to, supervised learning models such as neural networks, decision trees, linear regression, and support vector machines, unsupervised learning models such as Hidden Markov models, k-means, hierarchical clustering, and Gaussian mixture models, and reinforcement learning models such as temporal difference, deep adversarial networks, and Q-learning. In embodiments, the ML model 207 may include a plurality of encoders 630-1 through 630-n, a Long Short-Term Memory (LSTM) prediction model 640, and a decoder 650, for example, as shown in FIG. 6. Each of the plurality of encoders 630-1 through 630-n compresses corresponding 1-dimensional data to output a set of vectors. The set of vectors may be 8 vectors. The 1-dimensional data is output by the data conversion module 209. The LSTM prediction model 640 receives a plurality of the sets of vectors as input and outputs another set of vectors that are related to future presence of objects. The decoder 650 decompresses another set of vectors to obtain 1-dimensional data for future presence of objects. In some embodiments, the trained prediction machine learning model includes a plurality of encoders, a transformer, and a decoder.

The data conversion module 209 obtains a 2-dimensional matrix representing presence of objects in an area based on information about the presence of objects in each of the sub-regions of the area. For example, the data conversion module 209 of the vehicle 105 may obtain information that there were one vehicle in the sub-region 110-1, two vehicles in the sub-region 110-2, two vehicles in the sub-region 110-3, and four vehicles in the sub-region 110-4 at time t1 as shown in FIG. 1A. Based on the obtained information, the data conversion module 209 generates a 2-dimensional matrix representing the presence of vehicles in the area 110, e.g., the 2-dimensional matrix 420 in FIG. 4.

Then, the data conversion module 209 filters the 2-dimensional matrix based on map information. The map information may include information about drivable sub-regions and information about non-drivable sub-regions in the area. For example, by referring to FIG. 4, the sub-regions 430-1 through 430-5 are drivable sub-regions and the rest of the sub-regions are non-drivable. The data conversion module 209 filters the 2-dimensional matrix based on map information by selecting values in the 2-dimensional matrix corresponding to the drivable sub-regions and removing values in the 2-dimensional matrix corresponding to the non-drivable sub-regions. For example, by referring to FIG. 4, only the sub-regions 430-1 through 430-5 remain and the rest of the sub-regions are removed.

The filtering operation using the map information can be presented mathematically as follows. A is an m×n matrix which includes surrounding information, e.g., number of vehicles in each of sub-regions and B is an m×n matrix with binary elements which shared by all of the vehicles and has the map information for the city, i.e., B_{i,j}∈{0,1} for i=1, . . . , m and j=1, . . . , n. The element-wise multiplication of A and B, denoted by A⊙B, is an m×n matrix C, where the elements of C are given by: C_{i,j}=A_{i,j}*B_{i,j}. In other words, the value of C_{i,j} is the product of the values of A_{i,j} and B_{i,j}. If B_{i,j} is 1, then C_{i,j} will be equal to A_{i,j}. If B_{i,j} is 0, then C_{i,j} will be equal to 0. Thus, the operation of keeping the part of A where the location has 1 in B can be written as the element-wise multiplication of A and B: C=A⊙B where C is the resulting matrix that keeps only the values of A where B has a value of 1.

Then, the data conversion module 209 converts the filtered 2-dimensional matrix to 1-dimensional data. For example, by referring to FIG. 4, the remaining values for the sub-regions 420-1 through 420-5 in the filtered 2-dimensional matrix are converted to 1-dimensional data 440. This conversion method selects values in the filtered 2-dimensional matrix by moving from left to right, top to bottom. Specifically, the 1-dimensional data 440 includes values in the order of values in the sub-regions 420-1, 420-2, 420-3, 420-4, 420-5.

The ML training module 211 trains the ML model 207 to compress layers of the ML model 207 into a lower dimensional space. The ML training module 211 trains the ML model such that an output from the ML model 207 is identical to the input to the ML model 207 while minimizing the size of the middle layers of the ML model 207. Because the present system tries to determine the number of vehicles in an area, the Mean Squared Error (MSE) loss function below is used to train the ML model 207.

$$MSE = \frac{1}{N} {\sum }_{i = 1}^{N} {( {y}_{i} - {\hat{y}}_{i} )}^{2}$$

wherein yᵢ is the vector of observed values, and ŷᵢ is predicted values.

Referring still to FIG. 2, the first vehicle system 200 comprises one or more sensors 208. The one or more sensors 208 may include a forward facing camera installed in a vehicle. The one or more sensors 208 may be any device having an array of sensing devices capable of detecting radiation in an ultraviolet wavelength band, a visible light wavelength band, or an infrared wavelength band. The one or more sensors 208 may have any resolution. In some embodiments, one or more optical components, such as a mirror, fish-eye lens, or any other type of lens may be optically coupled to the one or more sensors 208. In embodiments described herein, the one or more sensors 208 may provide image data to the one or more processors 202 or another component communicatively coupled to the communication path 204. In some embodiments, the one or more sensors 208 may also provide navigation support. That is, data captured by the one or more sensors 208 may be used to autonomously or semi-autonomously navigate a vehicle. The first vehicle system 200 may detect external objects such as other vehicles using the one or more sensors 208.

In some embodiments, the one or more sensors 208 include one or more imaging sensors configured to operate in the visual and/or infrared spectrum to sense visual and/or infrared light. Additionally, while the particular embodiments described herein are described with respect to hardware for sensing light in the visual and/or infrared spectrum, it is to be understood that other types of sensors are contemplated. For example, the systems described herein could include one or more LIDAR sensors, radar sensors, sonar sensors, or other types of sensors for gathering data that could be integrated into or supplement the data collection described herein. Ranging sensors like radar sensors may be used to obtain a rough depth and speed information for the view of the first vehicle system 200.

The first vehicle system 200 comprises a satellite antenna 214 coupled to the communication path 204 such that the communication path 204 communicatively couples the satellite antenna 214 to other modules of the first vehicle system 200. The satellite antenna 214 is configured to receive signals from global positioning system satellites. Specifically, in one embodiment, the satellite antenna 214 includes one or more conductive elements that interact with electromagnetic signals transmitted by global positioning system satellites. The received signal is transformed into a data signal indicative of the location (e.g., latitude and longitude) of the satellite antenna 214 or an object positioned near the satellite antenna 214, by the one or more processors 202.

The first vehicle system 200 comprises one or more vehicle sensors 212. Each of the one or more vehicle sensors 212 is coupled to the communication path 204 and communicatively coupled to the one or more processors 202. The one or more vehicle sensors 212 may include one or more motion sensors for detecting and measuring motion and changes in motion of a vehicle, e.g., the vehicle 101. The motion sensors may include inertial measurement units. Each of the one or more motion sensors may include one or more accelerometers and one or more gyroscopes. Each of the one or more motion sensors transforms sensed physical movement of the vehicle into a signal indicative of an orientation, a rotation, a velocity, or an acceleration of the vehicle.

Still referring to FIG. 2, the first vehicle system 200 comprises network interface hardware 216 for communicatively coupling the first vehicle system 200 to the second vehicle system 220 and/or the edge device 106. The network interface hardware 216 can be communicatively coupled to the communication path 204 and can be any device capable of transmitting and/or receiving data via a network. Accordingly, the network interface hardware 216 can include a communication transceiver for sending and/or receiving any wired or wireless communication. For example, the network interface hardware 216 may include an antenna, a modem, LAN port, WiFi card, WiMAX card, mobile communications hardware, near-field communication hardware, satellite communication hardware and/or any wired or wireless hardware for communicating with other networks and/or devices. In one embodiment, the network interface hardware 216 includes hardware configured to operate in accordance with the Bluetooth® wireless communication protocol. The network interface hardware 216 of the first vehicle system 200 may transmit its data to the second vehicle system 220 or the edge device 106. For example, the network interface hardware 216 of the first vehicle system 200 may transmit vehicle data, location data, updated local model data and the like to the edge device 106.

The first vehicle system 200 may connect with one or more external vehicle systems (e.g., the second vehicle system 220) and/or external processing devices (e.g., the edge device 106) via a direct connection. The direct connection may be a vehicle-to-vehicle connection (“V2V connection”), a vehicle-to-everything connection (“V2X connection”), or a mmWave connection. The V2V or V2X connection or mmWave connection may be established using any suitable wireless communication protocols discussed above. A connection between vehicles may utilize sessions that are time-based and/or location-based. In embodiments, a connection between vehicles or between a vehicle and an infrastructure element may utilize one or more networks to connect, which may be in lieu of, or in addition to, a direct connection (such as V2V, V2X, mmWave) between the vehicles or between a vehicle and an infrastructure. By way of non-limiting example, vehicles may function as infrastructure nodes to form a mesh network and connect dynamically on an ad-hoc basis. In this way, vehicles may enter and/or leave the network at will, such that the mesh network may self-organize and self-modify over time. Other non-limiting network examples include vehicles forming peer-to-peer networks with other vehicles or utilizing centralized networks that rely upon certain vehicles and/or infrastructure elements. Still other examples include networks using centralized servers and other central computing devices to store and/or relay information between vehicles.

Still referring to FIG. 2, the first vehicle system 200 may be communicatively coupled to the edge device 106 by the network 250. In one embodiment, the network 250 may include one or more computer networks (e.g., a personal area network, a local area network, or a wide area network), cellular networks, satellite networks and/or a global positioning system and combinations thereof. Accordingly, the first vehicle system 200 can be communicatively coupled to the network 250 via a wide area network, via a local area network, via a personal area network, via a cellular network, via a satellite network, etc. Suitable local area networks may include wired Ethernet and/or wireless technologies such as, for example, Wi-Fi. Suitable personal area networks may include wireless technologies such as, for example, IrDA, Bluetooth®, Wireless USB, Z-Wave, ZigBee, and/or other near field communication protocols. Suitable cellular networks include, but are not limited to, technologies such as LTE, WiMAX, UMTS, CDMA, and GSM.

Still referring to FIG. 2, the second vehicle system 220 includes one or more processors 222, one or more memory modules 226, one or more sensors 228, one or more vehicle sensors 232, a satellite antenna 234, and a communication path 224 communicatively connected to the other components of the second vehicle system 220. The components of the second vehicle system 220 may be structurally similar to and have similar functions as the corresponding components of the first vehicle system 200 (e.g., the one or more processors 222 corresponds to the one or more processors 202, the one or more memory modules 226 corresponds to the one or more memory modules 206, the one or more sensors 228 corresponds to the one or more sensors 208, the one or more vehicle sensors 232 corresponds to the one or more vehicle sensors 212, the satellite antenna 234 corresponds to the satellite antenna 214, the communication path 224 corresponds to the communication path 204, the network interface hardware 236 corresponds to the network interface hardware 216, the ML model 227 corresponds to the ML model 207, a data conversion module 229 corresponds to the data conversion module 209, and a ML training module 231 corresponds to the ML training module 211).

Still referring to FIG. 2, the edge device 106 includes one or more processors 242, one or more memory modules 246, network interface hardware 248, and a communication path 244. The one or more processors 242 may be a controller, an integrated circuit, a microchip, a computer, or any other computing device. The one or more memory modules 246 may comprise RAM, ROM, flash memories, hard drives, or any device capable of storing machine readable and executable instructions such that the machine readable and executable instructions can be accessed by the one or more processors 242.

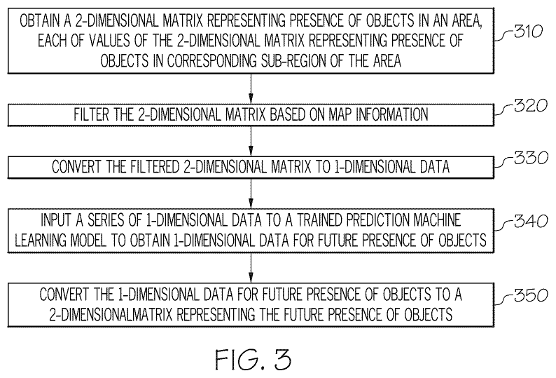

FIG. 3 depicts a flowchart for predicting presence of objects using decentralized data collection and city map data-based information compression, according to one or more embodiments shown and described herein.

In step 310, a controller (e.g., the controller of the first vehicle system 200 in FIG. 2) obtains a 2-dimensional matrix representing presence of objects in an area. The objects may include, but not limited to, vehicles, motorcycles, unmanned aerial vehicles, pedestrians, bicycles, and the like. Each of values of the 2-dimensional matrix represents presence of objects in corresponding sub-region of the area, e.g., the number of objects in corresponding sub-region.

In embodiments, by referring to FIG. 4, the controller obtains a 2-dimensional matrix representing presence of objects in an area 410 based on information about the presence of objects in each of the sub-regions of the area. For example, the controller may obtain information that there were one vehicle in the sub-region 110-1, two vehicles in the sub-region 110-2, two vehicles in the sub-region 110-3, and four vehicles in the sub-region 110-4 at time t1. The controller may obtain that no objects are detected in the remaining subj-regions of the area. In some embodiments, the controller does not obtain information about the presence of object in the remaining sub-regions of the area. Based on the obtained information, the controller generates a 2-dimensional matrix representing the presence of vehicles in the area 110, e.g., the 2-dimensional matrix 420 in FIG. 4. The 2-dimensional matrix includes values indicating the number of vehicles in corresponding sub-region. For example, the 2-dimensional matrix 420 is a 4 by 4 matrix which corresponds to the 4 by 4 sub-regions. The value 420-1 indicates the number of vehicles in corresponding sub-region 110-2. The value 420-2 indicates the number of vehicles in corresponding sub-region 110-1. The value 420-3 indicates the number of vehicles in corresponding sub-region 110-3. The value 420-4 indicates the number of vehicles in corresponding sub-region 110-8. The value 420-5 indicates the number of vehicles in corresponding sub-region 110-4.

Referring back to FIG. 3, in step 320, the controller filters the 2-dimensional matrix based on map information. By referring to FIG. 4, the map information may include a city map 430. The city map 430 may include drivable sub-regions and non-drivable sub-regions in the area. For example, the sub-regions 430-1 through 430-5 are drivable sub-regions and the rest of the sub-regions are non-drivable. The controller filters the 2-dimensional matrix based on the map information by selecting values in the 2-dimensional matrix corresponding to the drivable sub-regions and removing values in the 2-dimensional matrix corresponding to the non-drivable sub-regions. For example, by referring to FIG. 4, only the sub-regions 430-1 through 430-5 remain and the rest of the sub-regions are removed.

Referring back to FIG. 3, in step 330, the controller converts the filtered 2-dimensional matrix to 1-dimensional data. The controller converts the filtered 2-dimensional matrix to 1-dimensional data. For example, by referring to FIG. 4, the remaining values for the sub-regions 420-1 through 420-5 in the filtered 2-dimensional matrix are converted to 1-dimensional data 440. This conversion method selects values in the filtered 2-dimensional matrix by moving from top to bottom and left to right. Specifically, the 1-dimensional data 440 includes values in the order of the sub-regions 420-1, 420-2, 420-3, 420-4, 420-5. As illustrated in FIG. 4, the 4 by 4 raw data is dramatically reduced to five values data after filtering the raw data using map information and converting the filtered 2-dimensional matrix to the 1-dimensional matrix.

Referring back to FIG. 3, in step 340, the controller inputs a series of the 1-dimensional data to a trained prediction machine learning model to obtain 1-dimensional data for future presence of objects. By referring to FIG. 5, a series of 1-dimensional data 520, 522, 524 are input to a trained machine learning model or an autoencoder that includes encoders 530, an LSTM prediction model 532 and a decoder 534. Each of the 1-dimensional data is obtained by filtering 2-dimensional matrix data 510, 512, 514 using map information 518 and converting the filtered 2-dimensional matrix data to 1-dimensional data. The autoencoder receives the series of 1-dimensional data 520, 522, 524 and outputs 1-dimensional data 540 for future presence of objects.

Referring back to FIG. 3, in step 350, the controller converts the 1-dimensional data for future presence of objects to a 2-dimensional matrix representing the future presence of objects. By referring to FIG. 5, the controller processes the 1-dimensional data for future presence of objects to a 2-dimensional matrix 550 representing the future presence of objects.

FIG. 6 depicts processing of a plurality of 1-dimensional data by an autoencoder, according to one or more embodiments shown and described herein. The autoencoder includes a plurality of encoders 630-1 through 630-n. The plurality of 1-dimensional matrices 610-1 through 610-n are obtained from raw data obtained at different times, e.g., t1 through tn. Each of the encoders 630-1 through 630-n receives corresponding 1-dimensional matrix and outputs a set of vectors, e.g., 8 vectors. Then, a plurality of 8 vectors output from the plurality of encoders 630-1 through 630-n are input to the LSTM prediction model 640. The LSTM prediction model 640 receives the plurality of 8 vectors and outputs 8 vectors that are related to future presence of objects in the area. The decoder 650 receives the 8 vectors from the LSTM prediction model 640 and decodes the 8 vectors into 1-dimensional data 660.

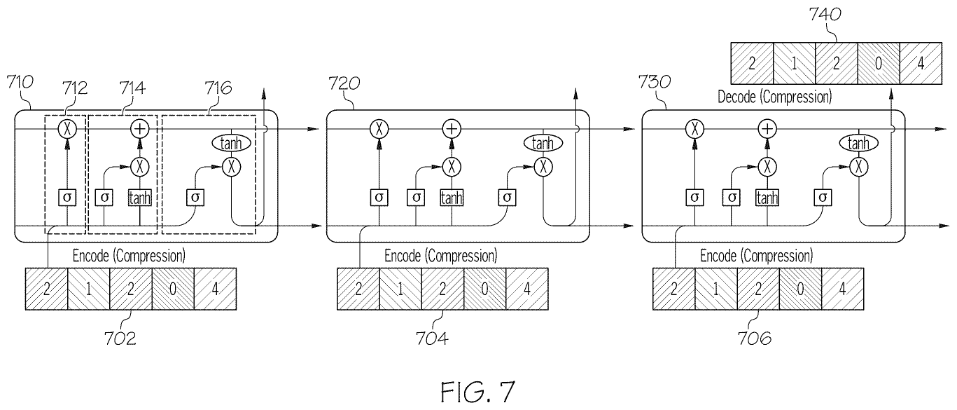

FIG. 7 depicts details of an LSTM prediction model, according to one or more embodiments shown and described herein.

An LSTM network is a type of recurrent neural network that is utilized for analyzing patterns over time and remembering information for a long time. The LSTM network works by using a special type of cell that can remember information and selectively forget or remember certain pieces of information. LSTM network also has gates that control the flow of information. FIG. 7 illustrates three LSTM units 710, 720 and 730, which receive data such as data encoded from 1-dimensional data 702, 704, 706 and produce an output which is decoded by a decoder to obtain 1-dimensional data 740. Each block of the LSTM units 710, 720, 730 consists of three parts. For example, as to the LSTM unit 710, a forget gate 712 combines the current input with the previous hidden state and passes the result through a sigmoid activation function. An input gate 714 determines which information to include in the current cell state. An output gate 716 produces the prediction and feeds data to the next cell. The final prediction can be obtained by extracting the output of the last LSTM unit, e.g., the LSTM unit 730.

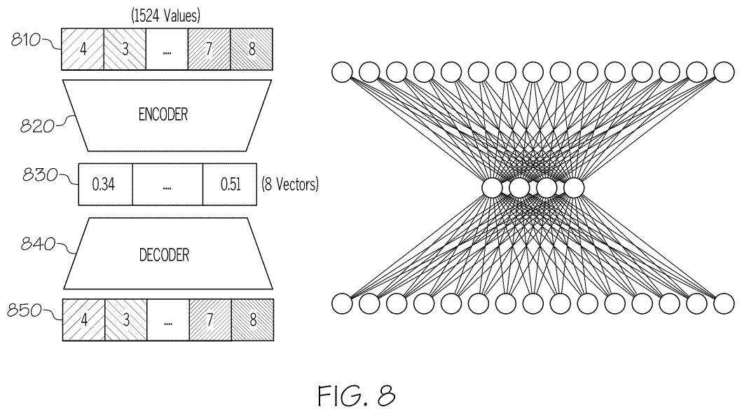

FIG. 8 depicts an autoencoder that compresses and decompresses data using an encoder and a decoder. In this example, the encoder 820 receives 1-dimensional data 810 that includes 1524 values and encodes the 1-dimensional data 810 to output 8 vectors 830. The 8 vectors 830 are input to the decoder 840 which decodes the 8 vectors into 1-dimensional data 850. The encoder 820 and the decoder 840 are trained such that the input 1-dimensional data 810 and the output 1-dimensional data 850 are the same while reducing the layers of the encoder 820 and the decoder 840.

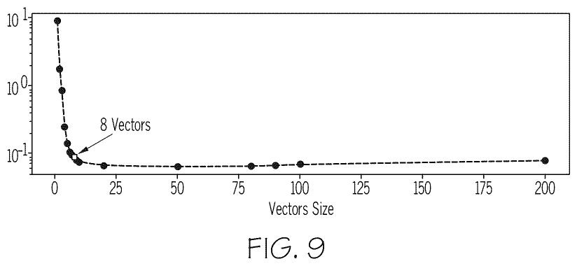

FIG. 9 depicts a graph that depicts a mean square error (MSE) loss for different number of vectors that are used by the encoder and the decoder in a simulated city traffic area. A significant increase in MSE loss occurs when the number of vectors decreases below 8, and there is no significant reduction in MSE loss when the number of vectors increases above 8. Thus, 8 vectors may be selected as the optimal number of vectors without sacrificing prediction accuracy significantly.

The filtering the 2-dimensional matrix using map information compresses data by 84.76%. Compressing using the encoder of the autoencoder compresses the data by 99.48% with 0.084 information loss. In total, the data has been compressed by 99.92% through map information filtering and compression by the encoder.

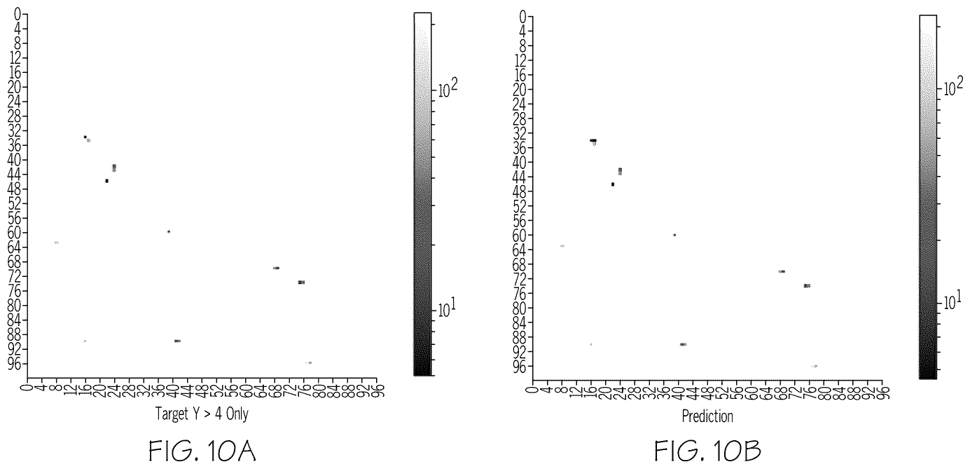

FIG. 10A depicts presence of vehicles in an area and FIG. 10B depicts prediction of presence of vehicles in the area using the present method of compressing data and predicting using the autoencoder.

It should be understood that embodiments described herein are directed to a method for long-term situational awareness for vehicles which utilizes information exchanged among vehicles to detect and understand the environment beyond the range of their own sensors. The method includes obtaining a 2-dimensional matrix representing presence of objects in an area, each of values of the 2-dimensional matrix representing presence of objects in corresponding sub-region of the area, filtering the 2-dimensional matrix based on map information, converting the filtered 2-dimensional matrix to 1-dimensional data, inputting a series of the 1-dimensional data to a trained prediction machine learning model to obtain 1-dimensional data for future presence of objects, and converting the 1-dimensional data for future presence of objects to a 2-dimensional matrix representing the future presence of objects.

Compared to conventional technologies, the present disclosure significantly compresses data for situational awareness without sacrificing accuracy of prediction, and thus, the present disclosure provides long-term situational awareness to vehicles while minimizing data storage and transmission costs.

It is noted that the terms “substantially” and “about” may be utilized herein to represent the inherent degree of uncertainty that may be attributed to any quantitative comparison, value, measurement, or other representation. These terms are also utilized herein to represent the degree by which a quantitative representation may vary from a stated reference without resulting in a change in the basic function of the subject matter at issue.

While particular embodiments have been illustrated and described herein, it should be understood that various other changes and modifications may be made without departing from the spirit and scope of the claimed subject matter. Moreover, although various aspects of the claimed subject matter have been described herein, such aspects need not be utilized in combination. It is therefore intended that the appended claims cover all such changes and modifications that are within the scope of the claimed subject matter.

What is claimed is:

1. A method for predicting presence of objects in an area, the method comprising:
obtaining a 2-dimensional matrix representing presence of objects in an area, each of values of the 2-dimensional matrix representing presence of objects in corresponding sub-region of the area;
filtering the 2-dimensional matrix based on map information;
converting the filtered 2-dimensional matrix to 1-dimensional data;
inputting a series of the 1-dimensional data to a trained prediction machine learning model to obtain 1-dimensional data for future presence of objects; and
converting the 1-dimensional data for future presence of objects to a 2-dimensional matrix representing the future presence of objects.

2. The method of claim 1, wherein the trained prediction machine learning model includes a plurality of encoders, a Long Short-Term Memory (LSTM) model, and a decoder.

3. The method of claim 2, wherein each of the plurality of encoders compresses corresponding 1-dimensional data to output a set of vectors;
the LSTM model receives a plurality of the sets of vectors as input and outputs another set of vectors; and
the decoder decompresses the another set of vectors to obtain the 1-dimensional data for future presence of objects.

4. The method of claim 3, wherein each of the set of vectors includes 8 vectors, and each of the another set of vectors includes 8 vectors.

5. The method of claim 1, wherein the trained prediction machine learning model includes a plurality of encoders, a transformer, and a decoder.

6. The method of claim 1, wherein the map information includes information about drivable sub-regions and information about non-drivable sub-regions in the area; and
filtering the 2-dimensional matrix based on the map information comprises selecting values in the 2-dimensional matrix corresponding to the drivable sub-regions and removing values in the 2-dimensional matrix corresponding to the non-drivable sub-regions.

7. The method of claim 6, wherein the 1-dimensional data includes the selected values.

8. The method of claim 1, further comprising training a prediction machine learning model to obtain the trained prediction machine learning model by:
reducing sizes of middle layers of the prediction machine learning model while an input to the prediction machine learning model matches with an output of the prediction machine learning model.

9. The method of claim 1, wherein the each of values of the 2-dimensional matrix represents a number of vehicles in corresponding sub-region of the area.

10. A system for predicting presence of objects in an area, the system comprising:
a controller programmed to:
obtain a 2-dimensional matrix representing presence of objects in an area, each of values of the 2-dimensional matrix representing presence of objects in corresponding sub-region of the area;
filter the 2-dimensional matrix based on map information;
convert the filtered 2-dimensional matrix to 1-dimensional data;
input a series of the 1-dimensional data to a trained prediction machine learning model to obtain 1-dimensional data for future presence of objects; and
convert the 1-dimensional data for future presence of objects to a 2-dimensional matrix representing the future presence of objects.

11. The system of claim 10, wherein the trained prediction machine learning model includes a plurality of encoders, a Long Short-Term Memory (LSTM) model, and a decoder.

12. The system of claim 11, wherein each of the plurality of encoders compresses corresponding 1-dimensional data to output a set of vectors;
the LSTM model receives a plurality of the sets of vectors as input and outputs another set of vectors; and
the decoder decompresses the another set of vectors to obtain the 1-dimensional data for future presence of objects.

13. The system of claim 12, wherein each of the set of vectors includes 8 vectors, and each of the another set of vectors includes 8 vectors.

14. The system of claim 10, wherein the trained prediction machine learning model includes a plurality of encoders, a transformer, and a decoder.

15. The system of claim 10, wherein the map information includes information about drivable sub-regions and information about non-drivable sub-regions in the area; and
filtering the 2-dimensional matrix based on the map information comprises selecting values in the 2-dimensional matrix corresponding to the drivable sub-regions and removing values in the 2-dimensional matrix corresponding to the non-drivable sub-regions.

16. The system of claim 14, wherein the 1-dimensional data includes the selected values.

17. The system of claim 10, wherein the controller is further programmed to:
train a prediction machine learning model to obtain the trained prediction machine learning model by:
reduce sizes of middle layers of the prediction machine learning model while an input to the prediction machine learning model matches with an output of the prediction machine learning model.

18. The system of claim 10, wherein the each of values of the 2-dimensional matrix represents a number of vehicles in corresponding sub-region of the area.

19. A non-transitory computer readable medium storing instructions, when executed by a processor, causing the processor to:
obtain a 2-dimensional matrix representing presence of objects in an area, each of values of the 2-dimensional matrix representing presence of objects in corresponding sub-region of the area;
filter the 2-dimensional matrix based on map information;
convert the filtered 2-dimensional matrix to 1-dimensional data;
input a series of the 1-dimensional data to a trained prediction machine learning model to obtain 1-dimensional data for future presence of objects; and
convert the 1-dimensional data for future presence of objects to a 2-dimensional matrix representing the future presence of objects.

20. The non-transitory computer readable medium of claim 19, wherein:
the trained prediction machine learning model includes a plurality of encoders, a Long Short-Term Memory (LSTM) model, and a decoder,
each of the plurality of encoders compresses corresponding 1-dimensional data to output a set of vectors;
the LSTM model receives a plurality of the sets of vectors as input and outputs another set of vectors; and
the decoder decompresses the another set of vectors to obtain the 1-dimensional data for future presence of objects.
